(19) United States
(12) Patent Application Publication
(10) Pub. No.: US 2026/0365588 A1
(43) Pub. Date: Nov. 19, 2026

(54) METHODS FOR COATING AND REPAIRING CONCRETE STRUCTURES USING A NOVEL HIGH PRESSURE POLYUREA COMPOUND

(71) Applicant: Brent Oribello, Fort Wayne, IN (US)

(72) Inventor: Brent Oribello, Fort Wayne, IN (US)

(21) Appl. No.: 19/652,915

(22) Filed: Apr. 20, 2026

Related U.S. Application Data
(60) Provisional application No. 63/791,109, filed on Apr. 18, 2025.

(51) Int. Cl. C04B 41/48; C04B 41/00; C04B 41/45; C04B 41/63; C09D 175/02; E04G 23/02

(52) U.S. Cl. CPC C04B 41/4884; C04B 41/009; C04B 41/4543; C04B 41/63; C09D 175/02; E04G 23/0203

(57) ABSTRACT

Methods for coating and repairing concrete structures using a polyurea compound are disclosed. In one embodiment, a polyurea compound is applied to a concrete surface to form a coating that repairs damaged portions of the concrete and provides a protective layer. The method may include preparing the concrete surface prior to application and applying the polyurea compound by spraying, brushing, or troweling. The polyurea compound may be formed by combining a first component comprising one or more isocyanates and a second component comprising one or more polyol resins, optionally with a pigment or colorant. The polyurea compound rapidly cures to form a durable layer that fills cracks and voids, restores structural integrity, and provides a moisture barrier that resists degradation from water, freeze-thaw cycles, and chemical exposure. The methods are particularly suitable for repairing and protecting infrastructure such as bridges and other concrete structures exposed to harsh environmental conditions.

### PRIORITY

The present application is related to, and claims the priority benefit of, U.S. provisional patent application Ser. No. 63/791,109, filed Apr. 18, 2025, the contents of which are incorporated herein directly and by reference in their entirety.

### BACKGROUND

Conventional methods of concrete repair, such as patching with cementitious materials, may not provide a long-term solution, especially in areas subjected to high stress, moisture, and exposure to chemicals, such as salt.

High pressure polyurea is a versatile, high-performance polymer that has excellent corrosion-resistant properties, a fast-curing nature, and high tensile strength. The present disclosure includes disclosure of methods for coating and repairing concrete structures using a novel polyurea compound, so to extend the lifespan and maintaining the safety of such infrastructure.

### BRIEF SUMMARY

The present disclosure includes disclosure of a method for repairing concrete, as shown and/or described herein.

The present disclosure includes disclosure of a method for coating concrete with a novel polyurea compound, as shown and/or described herein.

The present disclosure includes disclosure of a method for repairing concrete, comprising the step of applying a first coat of a polyurea compound of the present disclosure to concrete to coat the concrete.

The present disclosure includes disclosure of a method for repairing concrete, wherein the step of applying is performed by troweling or brushing the concrete with a quantity of the polyurea compound.

The present disclosure includes disclosure of a method for repairing concrete, wherein the step of applying is performed by spraying the concrete with a quantity of the polyurea compound.

The present disclosure includes disclosure of a method for repairing concrete, wherein the concrete is cleaned prior to the step of applying the polyurea compound.

The present disclosure includes disclosure of a method for repairing concrete, further comprising the step of applying a second layer of the polyurea compound to the concrete after the first coat has cured.

The present disclosure includes disclosure of a method, comprising the steps of combining a quantity of a first product with a quantity of a second product and mixing the same to form a polyurea compound of the present disclosure, and applying a first coat of the polyurea compound of the present disclosure to concrete to coat the concrete.

The present disclosure includes disclosure of a method, wherein the step of applying is performed by troweling or brushing the concrete with a quantity of the polyurea compound of the present disclosure.

The present disclosure includes disclosure of a method, wherein the step of applying is performed by spraying the concrete with a quantity of the polyurea compound of the present disclosure.

The present disclosure includes disclosure of a method, wherein the concrete is cleaned prior to the step of applying the polyurea compound of the present disclosure.

The present disclosure includes disclosure of a method, further comprising the step of applying a second layer of the polyurea compound of the present disclosure to the concrete after the first coat has cured.

The present disclosure includes disclosure of a method, wherein the step of combining a quantity of a first product with a quantity of a second product is performed to also combine a quantity of a colorant or a pigment thereto.

The present disclosure includes disclosure of a method for coating or repairing concrete, comprising the step of applying a first coat of a polyurea compound of the present disclosure to concrete to coat the concrete.

The present disclosure includes disclosure of a method for coating or repairing concrete, wherein the concrete is cleaned prior to applying the polyurea compound.

The present disclosure includes disclosure of a method for coating or repairing concrete, wherein cleaning comprises at least one of high-pressure water cleaning, brushing, scraping, or blowing the surface of the concrete.

The present disclosure includes disclosure of a method for coating or repairing concrete, wherein applying the polyurea compound comprises troweling or brushing the polyurea compound onto the concrete.

The present disclosure includes disclosure of a method for coating or repairing concrete, wherein applying the polyurea compound comprises spraying the polyurea compound onto the concrete.

The present disclosure includes disclosure of a method for coating or repairing concrete, wherein applying the polyurea compound comprises filling one or more cracks, voids, or surface imperfections in the concrete.

The present disclosure includes disclosure of a method for coating or repairing concrete, further comprising applying a second layer of the polyurea compound after the first coat has cured. The present disclosure includes disclosure of a method for coating or repairing concrete, wherein the first coat and the second layer define a multi-layer repair coating.

The present disclosure includes disclosure of a method for coating or repairing concrete, wherein the polyurea compound cures to form a layer that restores structural integrity of the concrete.

The present disclosure includes disclosure of a method for coating or repairing concrete, wherein the polyurea compound forms a moisture barrier on the concrete.

The present disclosure includes disclosure of a method for coating or repairing concrete, further comprising forming the polyurea compound by combining a first product and a second product.

The present disclosure includes disclosure of a method for coating or repairing concrete, wherein the first product comprises one or more isocyanates and the second product comprises one or more polyol resins.

The present disclosure includes disclosure of a method for coating or repairing concrete, wherein the first product and the second product are combined at a ratio of approximately 1:1 by volume.

The present disclosure includes disclosure of a method for coating or repairing concrete, wherein combining further comprises adding a pigment or colorant to the polyurea compound.

The present disclosure includes disclosure of a method for coating or repairing concrete, wherein the polyurea compound is sprayed at a pressure of at least about 2800 psi.

The present disclosure includes disclosure of a method for coating or repairing concrete, wherein the polyurea compound is heated to at least about 150 °F prior to spraying.

The present disclosure includes disclosure of a method for coating or repairing concrete, wherein spraying is performed using at least about 80 psi of air pressure at a spray nozzle.

The present disclosure includes disclosure of a method for coating or repairing concrete, wherein the concrete has a surface temperature of at least about 5 °F above a dew point during application.

The present disclosure includes disclosure of a method for coating or repairing concrete, wherein the polyurea compound is applied to a bridge or other infrastructure structure exposed to moisture, salts, or environmental conditions.

The present disclosure includes disclosure of a method for coating or repairing concrete, wherein the polyurea compound cures within seconds to minutes after application.

The present disclosure includes disclosure of a method for coating or repairing concrete, comprising preparing a surface of a concrete structure, forming a polyurea compound by combining a first product and a second product, and applying the polyurea compound to the surface of the concrete structure so as to coat the concrete structure and repair at least one damaged portion thereof.

The present disclosure includes disclosure of a method for coating or repairing concrete, wherein the concrete structure comprises a bridge, building, parking structure, roadway, wall, deck, floor, column, beam, support, or combinations thereof.

The present disclosure includes disclosure of a method for coating or repairing concrete, wherein preparing the surface comprises cleaning the surface.

The present disclosure includes disclosure of a method for coating or repairing concrete, wherein cleaning comprises using high-pressure water, brushing, scraping, blowing, or a combination thereof.

The present disclosure includes disclosure of a method for coating or repairing concrete, wherein preparing the surface improves adhesion of the polyurea compound to the concrete structure.

The present disclosure includes disclosure of a method for coating or repairing concrete, wherein applying the polyurea compound comprises pouring the polyurea compound onto the concrete structure.

The present disclosure includes disclosure of a method for coating or repairing concrete, wherein applying the polyurea compound comprises brushing the polyurea compound onto the concrete structure.

The present disclosure includes disclosure of a method for coating or repairing concrete, wherein applying the polyurea compound comprises troweling the polyurea compound onto the concrete structure.

The present disclosure includes disclosure of a method for coating or repairing concrete, wherein applying the polyurea compound comprises spraying the polyurea compound onto the concrete structure.

The present disclosure includes disclosure of a method for coating or repairing concrete, wherein applying the polyurea compound comprises filling one or more cracks, voids, chips, spalls, or surface imperfections in the concrete structure.

The present disclosure includes disclosure of a method for coating or repairing concrete, wherein the polyurea compound is applied in a first coat.

The present disclosure includes disclosure of a method for coating or repairing concrete, further comprising applying a second coat of the polyurea compound after the first coat has cured. The present disclosure includes disclosure of a method for coating or repairing concrete, wherein the first coat and the second coat cooperatively define a multi-layer repair coating on the concrete structure.

The present disclosure includes disclosure of a method for coating or repairing concrete, wherein the polyurea compound cures on the concrete structure to form a durable layer.

The present disclosure includes disclosure of a method for coating or repairing concrete, wherein the durable layer forms a moisture barrier on the concrete structure.

The present disclosure includes disclosure of a method for coating or repairing concrete, wherein the durable layer inhibits degradation of the concrete structure due to water infiltration.

The present disclosure includes disclosure of a method for coating or repairing concrete, wherein the durable layer inhibits degradation of the concrete structure due to freeze-thaw cycling.

The present disclosure includes disclosure of a method for coating or repairing concrete, wherein the durable layer inhibits degradation of the concrete structure due to chemical exposure.

The present disclosure includes disclosure of a method for coating or repairing concrete, wherein the polyurea compound restores structural integrity of the concrete structure by filling at least one crack or void.

The present disclosure includes disclosure of a method for coating or repairing concrete, wherein the polyurea compound comprises a first component and a second component that are combined prior to or during application.

The present disclosure includes disclosure of a method for coating or repairing concrete, wherein the first component comprises one or more isocyanates.

The present disclosure includes disclosure of a method for coating or repairing concrete, wherein the second component comprises one or more polyol resins.

The present disclosure includes disclosure of a method for coating or repairing concrete, wherein the first component and the second component are combined at a ratio of about 1:1 by volume.

The present disclosure includes disclosure of a method for coating or repairing concrete, wherein the first component and the second component are preconditioned to a temperature in a range of about 70 °F to about 80 °F prior to application.

The present disclosure includes disclosure of a method for coating or repairing concrete, wherein the first component and the second component are heated prior to spray application.

The present disclosure includes disclosure of a method for coating or repairing concrete, wherein the first component and the second component are heated to at least about 150 °F prior to spray application.

The present disclosure includes disclosure of a method for coating or repairing concrete, wherein the first component and the second component are pressurized prior to spray application.

The present disclosure includes disclosure of a method for coating or repairing concrete, wherein the first component and the second component are pressurized to at least about 2800 psi prior to spray application.

The present disclosure includes disclosure of a method for coating or repairing concrete, wherein spraying is performed using a spray apparatus having at least about 80 psi of air pressure at a spray gun nozzle.

The present disclosure includes disclosure of a method for coating or repairing concrete, wherein the concrete structure has a surface temperature that is at least about 5 °F above a dew point during application.

The present disclosure includes disclosure of a method for coating or repairing concrete, wherein the polyurea compound has a tack-free time in a range of about 10 seconds to about 30 seconds.

The present disclosure includes disclosure of a method for coating or repairing concrete, wherein the polyurea compound has a recoat window in a range of about 0 hours to about 6 hours.

The present disclosure includes disclosure of a method for coating or repairing concrete, wherein the polyurea compound is applied at a thickness greater than about 2 mm.

The present disclosure includes disclosure of a method for coating or repairing concrete, wherein forming the polyurea compound further comprises adding a pigment or colorant.

The present disclosure includes disclosure of a method for coating or repairing concrete, wherein the polyurea compound is substantially impermeable to water.

The present disclosure includes disclosure of a method for coating or repairing concrete, wherein the polyurea compound resists cracking or delamination during temperature fluctuation.

The present disclosure includes disclosure of a method for coating or repairing concrete, wherein the polyurea compound provides abrasion resistance to the concrete structure.

The present disclosure includes disclosure of a method for coating or repairing concrete, wherein the polyurea compound provides ultraviolet resistance to the concrete structure.

The present disclosure includes disclosure of a method for coating or repairing concrete, wherein the polyurea compound provides impact resistance to the concrete structure.

The present disclosure includes disclosure of a method for coating or repairing concrete, wherein the concrete structure is part of transportation infrastructure exposed to salts, moisture, or road debris.

The present disclosure includes disclosure of a method for coating or repairing concrete, wherein the polyurea compound comprises a high-pressure polyurea compound.

The present disclosure includes disclosure of a method for coating or repairing concrete, wherein applying the polyurea compound is performed on-site at the concrete structure.

The present disclosure includes disclosure of a method for coating or repairing concrete, wherein the repaired concrete structure is returned to service within about 1 hour to about 4 hours after application for foot traffic.

The present disclosure includes disclosure of a method for coating or repairing concrete, wherein the repaired concrete structure is returned to full service more than about 24 hours after application.

The present disclosure includes disclosure of a method for coating or repairing concrete, wherein the polyurea compound has an elongation of about 380%±50.

The present disclosure includes disclosure of a method for coating or repairing concrete, wherein the polyurea compound has a hardness of about 56±5 Shore D.

The present disclosure includes disclosure of a method for coating or repairing concrete, wherein the polyurea compound has a tensile strength of about 4400±200 psi.

The present disclosure includes disclosure of a method for coating or repairing concrete, wherein the polyurea compound has a tear strength of about 420±50 pli.

The present disclosure includes disclosure of a method for coating or repairing concrete, wherein the polyurea compound has a volatile organic compound content of about 0 gm/lit.

The present disclosure includes disclosure of a method for coating or repairing concrete, wherein the polyurea compound has a service temperature range from about −40 °F to about 250 °F.

The present disclosure includes disclosure of a method for forming and applying a concrete repair coating, comprising combining a first product comprising one or more isocyanates with a second product comprising one or more polyol resins to form a polyurea compound, and applying the polyurea compound to concrete to repair and coat the concrete.

The present disclosure includes disclosure of a method for forming and applying a concrete repair coating, wherein applying comprises spraying the polyurea compound onto the concrete.

The present disclosure includes disclosure of a method for forming and applying a concrete repair coating, further comprising cleaning the concrete before applying the polyurea compound.

The present disclosure includes disclosure of a method for forming and applying a concrete repair coating, further comprising applying a second coat of the polyurea compound after a first coat has cured.

The present disclosure includes disclosure of a method for forming and applying a concrete repair coating, further comprising adding a pigment or colorant while combining the first product and the second product.

The present disclosure includes disclosure of a repaired concrete structure produced by a method of the present disclosure.

The present disclosure includes disclosure of a repaired concrete structure comprising a cured polyurea layer adhered to a concrete substrate and filling at least one crack, void, chip, spall, or surface imperfection.

The present disclosure includes disclosure of a repaired concrete structure wherein the cured polyurea layer forms a moisture barrier on the concrete substrate.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows photographs of before and after repairing a section of concrete on a bridge with a novel polyurea compound, according to an exemplary embodiment of the present disclosure;

FIG. 2 shows photographs of before and after repairing a section of concrete on a bridge with a novel polyurea compound, according to an exemplary embodiment of the present disclosure;

FIG. 3 shows photographs of before and after repairing a section of concrete on a bridge with a novel polyurea compound, according to an exemplary embodiment of the present disclosure; and

FIG. 4 shows photographs of before and after repairing a section of concrete on a bridge with a novel polyurea compound, according to an exemplary embodiment of the present disclosure. As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

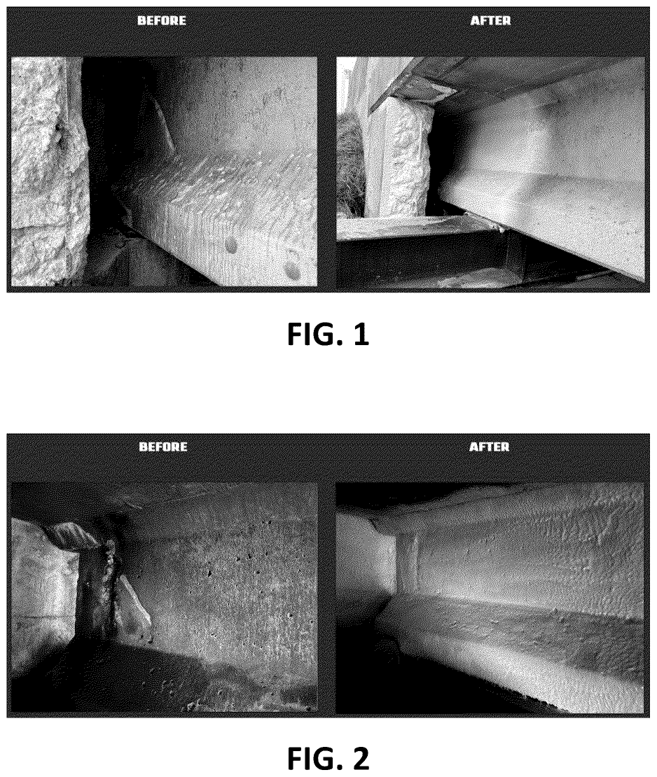

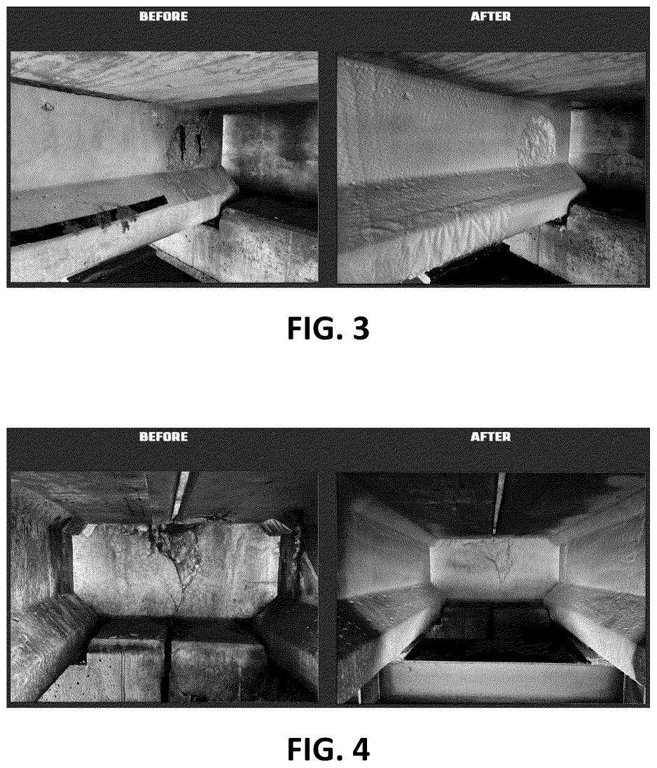

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes disclosure of methods for coating and repairing concrete structures using a novel polyurea compound.

Regarding concrete repair, such as repairing concrete bridges, buildings, parking structures, and the like, to extend their overall useful life, the present disclosure includes disclosure of applying novel polyurea compounds to damaged or deteriorating concrete. Said application can optionally include general surface preparation, such as by cleaning with high-pressure water, brushing, scraping, and/or blowing the surface of said concrete to be repaired so to improve overall adhesion of the novel polyurea compounds thereto. Novel polyurea compounds can be applied directly to the surface of the concrete by way of pouring, brushing, and/or spraying, and can be applied in multiple layers, as noted above, so to fill cracks, smooth out surface imperfections, and to otherwise repair the damaged concrete structure.

Once the novel polyurea compound cures on the concrete, it forms a durable and structurally sound layer that restores the overall structural integrity of the concrete, filling cracks and voids. In addition, the novel polyurea compound forms a moisture barrier, preventing further degradation of the concrete due to water infiltration, freeze-thaw cycles, or chemical exposure.

Uses of novel polyurea compounds of the present disclosure, such as in connection with coating concrete structure repair, can provide long-lasting protection against corrosion, significantly extending the life of concrete structures and reducing the need for expensive maintenance. The toughness, elasticity, and resistance of polyurea to environmental factors such as moisture, salts, and temperature fluctuations make it an ideal material for use in infrastructure subjected to harsh conditions.

Exemplary polyurea compounds of the present disclosure can comprise two separate components/parts that are combined when applied. A first component/part (also referred to herein as Part A) comprises one or more isocyanates, and a second component/part (also referred to as Part B) comprises one or more polyol resins. Prior to application, both components/parts can be preconditioned at 70 °F-80 °F prior to application. During application, and in an exemplary embodiment, both components/parts are compressed, such as to a minimum of 2800 psi, and are heated, such as to a minimum of 150 °F, prior to spray application. Adequate pressure and temperature should be maintained during the spray application process. Recommended surface temperature should be at least 5 °F above the dew point for proper adhesion and curing. The spray apparatus should maintain a minimum of 80 psi of air to spray the material through the spray gun nozzle.

Exemplary polyurea compounds of the present disclosure can have one or more of the following properties:
Mix Ratio, By Volume: 1 Part A: 1 Part B
Pot Life @ 150 °(66 °C): 4-8 seconds
Tack Free Time: 10-30 seconds
Recoat Window: 0-6 hours
Density (Sides A & B combined): 8.81 lbs/gal
Specific Gravity (Parts A & B combined): 1.10
Tensile, ASTM 412-C: 4400±200 psi
Hardness, ASTM D-2240: 56±5 Shore D
Tear, ASTM 624-C: 420±50 pli
Elongation, ASTM 412-C: 380%±50
VOC Content: 0 gm/lit
Service Temperature: −40 to 250 °F (−40 to 121 °C)
Return to Service, Foot Traffic: 1-4 hours
Recommended Applied Thickness: >2 mm
Resistance to Weathering, ASTM G-23: No cracking or blistering.
Color Change, gloss reduction and chalking are noted. (Type QUV Weatherometer—3000 hour exposure)
Return to Service, Full Service: >24 hours
Taber Abrasion Resistance, ASTM D4060: 20 mg loss (CS17 wheel, 1000 cycles, 1 kg load) (maximum)
Water Permeability, ASTM E-96: 0.05 perm-inch
Crack Bridging, ASTM C836: Pass (−13 °F (−25 °C), 1.6 mm crack, 25 cycles)
Inter-Coat Adhesion (within recoat time): Excellent
Water Absorption, ASTM D 471: <0.5% (maximum 73 °F (23 °C), 24 hours)
Concrete (primed), substrate failure occurred: >500 psi Impact Resistance @77 °F (25 °C), ASTM G14: >200 lbs
Lineal Shrinkage: 1-2% Concrete (shot blasted profile), substrate failure occurred: >500 psi
Steel (90 um blast profile): >900 psi
Flexibility (⅛″3 mm Mendrel Bend Test) ASTM D1737: Pass Exemplary polyurea compounds of the present disclosure can be formed by combining relative amounts of two separate products (referred to herein as Part A and Part B). In at least one embodiment, the ratio of mixing each product is 1:1.

In general, coating performance and adhesion are directly proportional to surface preparation. Most failures in the performance of surface coatings can be attributed to poor surface preparation. Polyurea coatings of the present disclosure rely on the structural strength of the substrate to which they are applied. All surfaces must be free of dust, dirt, oil, grease, rust, corrosion, and other contaminants. When coating substrates previously used, it is important to consider the possibility of substrate absorption, which may affect the adhesion of the coating system, regardless of the surface preparation.

The novel polyurea compounds of the present disclosure were specifically designed for the protection of bridges and infrastructure. This advanced formulation combines the best qualities of traditional polyurea with other specialized components to provide superior protection, durability, and long-term performance in even the most demanding environments.

The novel polyurea compounds of the present disclosure create an impermeable barrier that effectively prevents water, salts, and other corrosive elements from penetrating the surfaces of concrete. This is especially crucial in areas with harsh winters, where the use of de-icing salts accelerates corrosion in bridges and infrastructure.

The novel polyurea compounds of the present disclosure have flexibility and abrasion resistance that enhances the durability of bridges and infrastructure. It resists cracking and delamination, even during temperature fluctuations and freeze-thaw cycles, which are common in colder regions. This makes it particularly effective in extending the lifespan of structures by 20-50%, depending on environmental conditions.

The novel polyurea compounds of the present disclosure offer superior adhesion to concrete surfaces, creating a seamless and protective bond that is highly resistant to abrasion, impact, and shear forces. The flexibility of the polyurea hybrid ensures that it can expand and contract with the material it is applied to, providing continued protection without cracking or peeling. The coating's flexibility ensures it withstands the stresses caused by concrete movement without compromising its protective capabilities.

One of the standout features of the novel polyurea compounds of the present disclosure is its rapid curing time. The coating cures in a matter of seconds to minutes, meaning the application process is fast and minimizes downtime. This is crucial for infrastructure projects that need to be completed quickly to reduce disruption to traffic and daily operations. Since polyurea hybrid coatings of the present disclosure cure quickly, contractors can apply them to concrete on-site, streamlining the construction process. This is especially beneficial in large-scale bridge or infrastructure projects where time is of the essence.

The novel polyurea compounds of the present disclosure offer outstanding ultraviolet (UV) light resistance, protecting the coating from degradation caused by sunlight. The coating retains its color and structural integrity even after prolonged exposure to harsh environmental elements. This makes it an excellent choice for bridges and infrastructure exposed to the elements year-round. The durability of the hybrid coating extends the lifespan of the structure by preventing premature breakdown.

The novel polyurea compounds of the present disclosure offer high impact resistance, making it ideal for bridges and other structures exposed to high traffic loads, heavy vehicles, and road debris. It also provides abrasion resistance, ensuring the coated surface remains intact despite frequent contact with heavy machinery, weathering, and environmental wear.

Long-term benefits of using novel polyurea compounds of the present disclosure far outweigh the upfront investment. Reduced maintenance costs, fewer repairs, and a longer lifespan result in significant savings over time. The durability of the coating means fewer reapplications and less downtime, making it a highly cost-effective choice for long-term infrastructure management.

Novel polyurea compounds of the present disclosure are low in volatile organic compounds (VOCs), making it an environmentally friendly option for coating bridges and infrastructure. It contributes to sustainable construction practices by offering long-term protection that reduces the need for frequent maintenance or replacement.

Novel polyurea compounds of the present disclosure can be prepared in a range of colors and finishes with the polyurea hybrid, allowing for customization that can match aesthetic requirements or visual appeal for public infrastructure projects. This allows bridges and infrastructure to maintain a clean, attractive appearance over time without the need for frequent touch-ups or repairs. Colorants or pigments can be added to the novel polyurea compounds to produce the desired colored product.

Novel polyurea compounds of the present disclosure offer a game-changing solution for coating bridges and infrastructure. With its superior corrosion protection, abrasion resistance, UV stability, and quick application times, this hybrid coating significantly extends the lifespan of infrastructure, reduces maintenance and repair costs, and improves the structural integrity of both concrete and steel components. When applied to bridges exposed to harsh weather conditions, novel polyurea compounds of the present disclosure provide an effective, cost-efficient, and durable solution that offers both short-and long-term benefits for infrastructure projects.

Polyurea-coated bridges can provide substantial savings over the long term due to reduced maintenance, extended lifespan, and enhanced durability. While the exact amount of savings can vary depending on factors like climate, bridge size, traffic loads, and specific environmental conditions, here are some key areas where polyurea coatings contribute to cost savings:

Polyurea coatings create a highly effective barrier against moisture, de-icing salts, and other environmental elements that lead to corrosion. For bridges in cold climates (like the Midwest, where salt is used extensively during winter), corrosion is one of the biggest causes of deterioration. Studies suggest that bridges treated with corrosion-resistant coatings can see a 50-60% reduction in corrosion-related maintenance costs.

Polyurea coatings can extend the service life of a bridge by 25-50%, depending on the conditions. A longer service life means fewer major repairs and delayed need for replacement, which can be cost-prohibitive. By increasing the service life of a bridge by up to 30 years, the need for premature replacements and large-scale renovations can be avoided. For example, a bridge replacement could cost anywhere from $5 million to $10 million, depending on the location and size of the bridge, whereas a polyurea coated bridge could delay that replacement by several decades.

Polyurea coatings cure quickly, allowing for faster application and reducing the time the bridge is out of service for repairs. This leads to fewer traffic disruptions, lower economic losses due to downtime, and reduced costs associated with traffic management during repairs. The ability to apply coatings quickly and resume traffic operations can lead to significant savings in terms of lost productivity and business. In high-traffic areas, this could result in millions of dollars in savings in indirect costs associated with downtime, rerouting, and detours.

Unlike traditional coatings, which may need to be re-applied every few years, polyurea coatings can last decades without significant wear. This reduces the frequency of re-coating and maintenance cycles, translating to lower costs over time. Polyurea-coated surfaces could reduce the need for re-coating by 40-50% over the structure's lifespan. The initial investment in polyurea coating may be higher, but the savings on re-coating can amount to significant reductions in overall maintenance expenses. Repairing cracked concrete can cost anywhere from $500,000 to $1 million for an average-sized bridge, which would be significantly reduced with polyurea protection.

Polyurea's quick cure time not only reduces downtime but also reduces labor costs. Contractors can apply the coatings faster, reducing the overall time and manpower required for each maintenance or repair cycle. Faster application and less labor-intensive maintenance can reduce labor costs by up to 15-20% for bridge maintenance projects.

Polyurea coatings are low in VOCs and environmentally friendly. The reduced need for chemical-based sealants and coatings lowers the environmental impact and aligns with sustainable infrastructure practices. The savings from avoiding reapplication of chemical coatings and reducing repair waste are additional benefits. Environmental regulations and the cost of disposing of toxic materials could add up to $50,000 to $200,000 over the life of a bridge without polyurea, especially in regions with stricter environmental laws.

Polyurea coatings may have a higher upfront cost compared to traditional coatings like epoxy or bitumen. However, their long-term performance and durability result in a net savings over time due to fewer repairs and extended service life. The long-term savings from using polyurea coatings, including fewer repairs, reduced downtime, and less frequent re-coating, can amount to 30-50% in overall maintenance costs compared to traditional coatings, often justifying the higher initial expense.

By utilizing polyurea-coated bridges, you can expect to save significantly on maintenance, repair, and replacement costs. Over the life span of the bridge, potential savings can range from several hundred thousand dollars to millions of dollars, depending on factors like the size of the bridge, its location, traffic load, and environmental conditions. For example, a typical highway bridge in the Midwest could see savings of $1 million to $5 million or more over its lifetime due to the protection offered by polyurea coatings. These savings come from reduced need for major repairs, delayed bridge replacements, lower traffic management costs, and fewer re-coating cycles

Polyurea coatings provide a high-performance solution for long-term infrastructure management, improving asset longevity and driving significant cost savings over time.

While various embodiments of methods for coating concrete have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A method for coating or repairing concrete, comprising the step of:
applying a first coat of a polyurea compound of the present disclosure to concrete to coat the concrete.

2. The method of claim 1, wherein the concrete is cleaned prior to applying the polyurea compound.

3. The method of claim 2, wherein cleaning comprises at least one of high-pressure water cleaning, brushing, scraping, or blowing the surface of the concrete.

4. The method of claim 1, wherein applying the polyurea compound comprises troweling or brushing the polyurea compound onto the concrete.

5. The method of claim 1, wherein applying the polyurea compound comprises spraying the polyurea compound onto the concrete.

6. The method of claim 1, wherein applying the polyurea compound comprises filling one or more cracks, voids, or surface imperfections in the concrete.

7. The method of claim 1, further comprising applying a second layer of the polyurea compound after the first coat has cured.

8. The method of claim 7, wherein the first coat and the second layer define a multi-layer repair coating.

9. The method of claim 1, wherein the polyurea compound cures to form a layer that restores structural integrity of the concrete.

10. The method of claim 1, wherein the polyurea compound forms a moisture barrier on the concrete.

11. The method of claim 1, further comprising forming the polyurea compound by combining a first product and a second product.

12. The method of claim 11, wherein the first product comprises one or more isocyanates and the second product comprises one or more polyol resins.

13. The method of claim 11, wherein the first product and the second product are combined at a ratio of approximately 1:1 by volume.

14. The method of claim 11, wherein combining further comprises adding a pigment or colorant to the polyurea compound.

15. The method of claim 5, wherein the polyurea compound is sprayed at a pressure of at least about 2800 psi.

16. The method of claim 5, wherein the polyurea compound is heated to at least about 150 °F prior to spraying.

17. The method of claim 5, wherein spraying is performed using at least about 80 psi of air pressure at a spray nozzle.

18. The method of claim 1, wherein the concrete has a surface temperature of at least about 5 °F above a dew point during application.

19. The method of claim 1, wherein the polyurea compound is applied to a bridge or other infrastructure structure exposed to moisture, salts, or environmental conditions.

20. The method of claim 1, wherein the polyurea compound cures within seconds to minutes after application.
